(19) United States
(12) Patent Application Publication
(10) Pub. No.: US 2019/0114628 A1
(43) Pub. Date: Apr. 18, 2019

(54) SYSTEMS AND METHODS FOR PARSING AND DECRYPTING PAYLOADS

(71) Applicant: Bluefin Payment Systems LLC, Atlanta, GA (US)

(72) Inventors: Timothy William Barnett, Roswell, GA (US); Donal McCarthy, Waterford (IE)

(21) Appl. No.: 16/159,356

(22) Filed: Oct. 12, 2018

Related U.S. Application Data
(60) Provisional application No. 62/571,358, filed on Oct. 12, 2017.

(51) Int. Cl. G06Q 20/38; G06Q 20/40

(52) U.S. Cl. CPC G06Q 20/3829; G06Q 20/204; G06Q 20/4018

(57) ABSTRACT

The present systems and methods generally relate to parsing encrypted transaction information received from a point of interaction device via a third party entity. Using a unique logic process, the present systems and methods can parse both encrypted and decrypted transaction information, such that the transaction information may be processed for payment authorization. For example, in certain embodiments, the present systems and methods receive a payload (and potentially other information), parse the payload into discrete data components, transmit one or more of the discrete data components to a decryption service, receive decrypted transaction information from the decryption service, and parse the decrypted transaction information into useful components such that payment may be authorized.

### CROSS REFERENCE TO RELATED APPLICATIONS

This application claims priority to, the benefit under 35 U.S.C. § 119 of, and incorporates by reference herein in its entirety U.S. Provisional Patent Application No. 62/571,358, filed Oct. 12, 2017, and entitled “Systems and Methods for Parsing and Decrypting Payloads.”

This application incorporates by reference herein the following U.S. and international patent applications:

U.S. Patent Application No. 61/955,739 entitled “Systems and Methods of Point of Interaction Management,” filed Mar. 19, 2014;

U.S. patent application Ser. No. 14/591,171, entitled “Point to Point Encryption Management Systems and Methods,” filed Jan. 7, 2015;

U.S. patent application Ser. No. 14/663,238, entitled “Systems and Methods for Decryption as a Service,” filed Mar. 19, 2015, now U.S. Pat. No. 9,461,973, issued Oct. 4, 2016;

U.S. patent application Ser. No. 15/218,332, entitled “Systems and Methods for Decryption as a Service Via a Message Queuing Protocol,” filed Jul. 25, 2016, now U.S. Pat. No. 9,531,712, issued Dec. 27, 2016;

U.S. patent application Ser. No. 14/591,218, entitled “Systems and Methods for Creating and Tracking States of Encryption Devices,” filed Jan. 7, 2015;

U.S. patent application Ser. No. 14/591,223, entitled “Systems and Methods for Creating Fingerprints of Encryption Devices,” filed Jan. 7, 2015, now U.S. Pat. No. 9,355,374, issued May 31, 2016;

U.S. patent application Ser. No. 14/139,034, entitled “Creating Fingerprints of Encryption Devices for Compromise Mitigation,” filed Apr. 26, 2016, now U.S. Pat. No. 9,953,316, issued Apr. 24, 2018;

International Application No. PCT/US15/10405, entitled “Systems and Methods for Creating Fingerprints of Encryption Devices,” filed Jan. 7, 2015;

Japanese National Phase Application No. 2017-500803, entitled “Systems and Methods for Creating Fingerprints of Encryption Devices,” filed Sep. 20, 2016, now Japanese Patent No. 6356896, issued Jun. 22, 2018;

European National Phase Application No. 15765006.0, entitled “Systems and Methods for Creating Fingerprints of Encryption Devices,” filed Oct. 19, 2016;

U.S. patent application Ser. No. 15/218,341, entitled “Systems and Methods for Decryption as a Service Via a Configuration of Read-Only Databases,” filed Jul. 25, 2016, now U.S. Pat. No. 9,531,684, issued Dec. 27, 2016;

U.S. patent application Ser. No. 15/386,730, entitled “Systems and Methods for Decryption as a Service Via a Configuration of Read-Only Databases,” filed Dec. 21, 2016;

U.S. patent application Ser. No. 15/218,352, entitled “Systems and Methods for Decryption as a Service Via a Hardware Security Module,” filed Jul. 25, 2016, now U.S. Pat. No. 9,686,250, issued Jun. 20, 2017;

U.S. patent application Ser. No. 15/386,707, entitled “Systems and Methods for Decryption as a Service Via a Message Queuing Protocol,” filed Dec. 21, 2016, now U.S. Pat. No. 9,692,735, issued Jun. 27, 2017;

U.S. patent application Ser. No. 15/597,402, entitled “Systems and Methods for Decryption as a Service Via a Hardware Security Module,” filed May 17, 2017, now U.S. Pat. No. 10,044,686, issued Aug. 7, 2018;

U.S. patent application Ser. No. 15/603,976, entitled “Systems and Methods for Decryption as a Service Via a Message Queuing Protocol,” filed May 24, 2017, now U.S. Pat. No. 10,027,635, issued Jul. 17, 2018;

U.S. patent application Ser. No. 15/253,352, entitled “Systems and Methods for Decryption as a Service,” filed Aug. 31, 2016, now U.S. Pat. No. 9,954,830, issued Apr. 24, 2018;

International Patent Application No. PCT/US15/21595, entitled “Systems and Methods for Decryption as a Service,” filed Mar. 19, 2015;

Japanese National Phase Application No. 2017-501120, entitled “Systems and Methods for Creating Fingerprints of Encryption Devices,” filed Sep. 20, 2016, now Japanese Patent No. 6261804, issued Dec. 22, 2017; and

European National Phase Application No. 15/765781.8, entitled “Systems and Methods for Decryption as a Service,” filed Oct. 19, 2016.

### TECHNICAL FIELD

The present systems and methods relate generally to decrypting payloads from various point of interaction devices, and more particularly to systems and methods for decrypting payloads received by third parties from various point of interaction devices.

### BACKGROUND

In today's technologically driven society, electronic payment processing has long surpassed cash as the preferred method of completing transactions. As such, the methods directed towards illegally obtaining electronic payment information have increased in volume and complexity. As increasingly more individuals engage in electronic payment processing, increasingly more scammers and thieves seek to steal from those individuals. Thus, the reliability and security of payment processing networks are a constant pain point for retailers, payment processors, and other third parties involved in the electronic payment process.

Third parties (i.e., partners) receiving electronic payment information (e.g., payloads) in particular are presented with several challenges in the electronic payment process. These partners must often perform several steps prior to obtaining payment authorization. Further, the steps involved may vary depending on the type of point of interaction (“POI”) device used, as each POI device may format payloads differently. As such, each new device that the particular partner adds to its network of devices potentially represents a new development effort that may require additional resource expenditure (e.g., time, money, labor, etc.). Therefore, there is a long-felt but unresolved need for a system or method that can receive a payload from a partner, process the payload, decrypt the payload, and securely return discrete data to the partner in a format substantially ready to be sent to a processor for authorization of payment.

### BRIEF SUMMARY OF THE DISCLOSURE

According to various aspects of the present disclosure, and in one embodiment, the present systems and methods allow a third party entity (e.g., a partner) to transmit payloads received from point of interaction (“POI”) devices to a system for parsing and decrypting, such that the partner may receive the information needed for processing payment specifically formatted such that the data can be further processed and payment may be authorized. In traditional partner-included payment systems, upon receipt of a payload, partners are typically required to conduct several steps, including parsing the payload, in order to receive authorization of payment. According to various aspects of the present disclosure, the present systems and methods eliminate the need for the partner to parse the needed fields prior to receiving decrypted payload information suitable for payment authorization.

According to a first aspect, the present systems and methods, in various embodiments, may include a system for decrypting payloads, the system including a computer server including at least one processor configured for: receiving a payload originating from a point of interaction device and partner authentication information from a partner, authenticating the partner via the partner authentication information, parsing the payload into a first set of one or more discrete portions including: A) a device serial number; B) a key sequence number; C) a cbc vector; and D) at least one encrypted portion; transmitting the at least one encrypted portion of the first set to a decryption service, the decryption service for decrypting the at least one encrypted portion, receiving decrypted credit card information derived from the at least one encrypted portion from the decryption service, parsing the decrypted credit card information into a second set of one or more discrete portions including: E) a credit card number; F) an expiration date; and G) a CVV code; and transmitting, to the partner, at least the second set.

According to a second aspect, the present systems and methods may include, the system of the first aspect or any other aspect, wherein the at least one processor is further configured for: receiving a client identifier and/or a reference number from the partner, caching the client identifier and/or the reference number, and transmitting, to the partner, the client identifier and/or the reference number with the credit card number, the expiration date, and the CVV code.

According to a third aspect, the present systems and methods may include, the system of the first aspect or any other aspect, wherein the first set includes discrete data objects.

According to a fourth aspect, the present systems and methods may include, the system of the first aspect or any other aspect, wherein the second set includes discrete data objects.

According to a fifth aspect, the present systems and methods may include, the system of the first aspect or any other aspect, wherein the partner authentication information includes a partner identifier and a partner key.

According to a sixth aspect, the present systems and methods may include, the system of the first aspect or any other aspect, wherein the first set is encoded.

According to a seventh aspect, the present systems and methods may include, the system of the sixth aspect or any other aspect, wherein the first set is encoded in hexadecimal format.

According to an eighth aspect, the present systems and methods may include, the system of the sixth aspect or any other aspect, wherein the first set is encoded in Unicode.

According to a ninth aspect, the present systems and methods may include, the system of the sixth aspect or any other aspect, wherein the first set is encoded in binary coded decimal.

According to a tenth aspect, the present systems and methods may include, the system of the sixth aspect or any other aspect, wherein the first set is encoded in base64.

According to an eleventh aspect, the present systems and methods may include, the system of the first aspect or any other aspect, wherein the point of interaction device is wireless.

According to a twelfth aspect, the present systems and methods, in various embodiments, may include a method for decrypting payloads, the method including: receiving, at a server, a payload originating from a point of interaction device and partner authentication information from a partner, authenticating the partner via the partner authentication information, parsing the payload into a first set of one or more discrete portions including: A) a device serial number; B) a key sequence number; C) a cbc vector; and D) at least one encrypted portion; transmitting the at least one encrypted portion of the first set to a decryption service, the decryption service for decrypting the at least one encrypted portion, receiving decrypted credit card information derived from the at least one encrypted portion from the decryption service, parsing the decrypted credit card information into a second set of one or more discrete portions including: E) a credit card number; F) an expiration date; and G) a CVV code; and transmitting, to the partner, the second set.

According to a thirteenth aspect, the present systems and methods may include, the method of the twelfth aspect or any other aspect, the method further including: receiving a client identifier and/or a reference number from the partner, caching the client identifier and/or the reference number, and transmitting, to the partner, the client identifier and/or the reference number with the credit card number, the expiration date, and the CVV code.

According to a fourteenth aspect, the present systems and methods may include, the method of the twelfth aspect or any other aspect, wherein the first set includes discrete data objects.

According to a fifteenth aspect, the present systems and methods may include, the method of the twelfth aspect or any other aspect, wherein the second set includes discrete data objects.

According to a sixteenth aspect, the present systems and methods may include, the method of the twelfth aspect or any other aspect, wherein the partner authentication information includes a partner identifier and a partner key.

According to a seventeenth aspect, the present systems and methods may include, the method of the twelfth aspect or any other aspect, wherein the first set is encoded.

According to an eighteenth aspect, the present systems and methods may include, the method of the seventeenth aspect or any other aspect, wherein the first set is encoded in hexadecimal format.

According to a nineteenth aspect, the present systems and methods may include, the method of the seventeenth aspect or any other aspect, wherein the first set is encoded in Unicode.

According to a twentieth aspect, the present systems and methods may include, the method of the seventeenth aspect or any other aspect, wherein the first set is encoded in binary coded decimal.

According to a twenty-first aspect, the present systems and methods may include, the method of the seventeenth aspect or any other aspect, wherein the first set is encoded in base64.

According to a twenty-second aspect, the present systems and methods may include, the method of the twelfth aspect or any other aspect, wherein the point of interaction device is wireless.

According to a twenty-third aspect, the present systems and methods, in various embodiments, may include a parser system for decrypting payloads including a computer server operatively connected to a parser system and a decryption service, the parser system including at least one processor configured for: receiving, from the partner system: A) a payload originating from a point of interaction (POI) device; and B) a partner identifier; parsing the payload into a first set of discrete data objects, the first set of discrete data objects including: C) a device serial number; and D) at least one encrypted portion; transmitting the first set of discrete data objects to a decryption system, wherein the decryption system uses the device serial number to verify that the POI device has not been compromised, receiving, from the decryption system: E) an indication of success of decrypting the at least one encrypted portion of the first set of discrete data objects; and F) decrypted credit card information; parsing the decrypted credit card information into a second set of discrete data objects including: G) a credit card number; H) an expiration date; and I) a CVV code; and transmitting to the partner system the following as discrete data objects: J) the credit card number; K) the expiration date; L) the CVV code; and M) the indication of success.

According to a twenty-fourth aspect, the present systems and methods may include, the system of the twenty-third aspect or any other aspect, wherein the first set of discrete data objects further includes a sequence number and a cbc vector.

According to a twenty-fifth aspect, the present systems and methods may include, the system of the twenty-third aspect or any other aspect, wherein the decryption system verifies that the POI device has not been compromised by: A) receiving the first set of discrete data objects in a particular format; and B) comparing the particular format to a fingerprint for the POI device, the fingerprint including a record of a known format for payloads originating from the POI device.

According to a twenty-sixth aspect, the present systems and methods, in various embodiments, may include a method for facilitating decryption of electronic payment information including: receiving encrypted electronic payment information, the encrypted electronic payment information originating from a point of interaction device, determining the format of the encrypted electronic payment information, parsing the encrypted electronic payment information into data segments, the data segments including: A) at least one encrypted track; and B) a serial number; transmitting the data segments to a decryption service, receiving decrypted electronic payment information from the decryption service, parsing the decrypted electronic payment information into decrypted data segments, the decrypted data segments including: C) at least one decrypted track, the decrypted track including credit card data; and D) a client identifier, the client identifier for identifying the point of interaction device; and transmitting at least the decrypted data segments to a third-party.

According to a twenty-seventh aspect, the present systems and methods may include, the method of the twenty-sixth aspect or any other aspect, wherein the data segments include a sequence number.

According to a twenty-eighth aspect, the present systems and methods may include, the method of the twenty-sixth aspect or any other aspect, wherein the data segments include a cbc vector.

According to a twenty-ninth aspect, the present systems and methods may include, the method of the twenty-sixth aspect or any other aspect, wherein a processor transmits third-party identification information to the decryption service.

According to a thirtieth aspect, the present systems and methods may include, the method of the twenty-ninth aspect or any other aspect, wherein the third-party identification information includes a third-party identifier and a third-party key.

According to a thirty-first aspect, the present systems and methods may include, the method of the twenty-sixth aspect or any other aspect, wherein the encrypted payment information is encrypted using hexadecimal encoding.

According to a thirty-second aspect, the present systems and methods may include, the method of the twenty-sixth aspect or any other aspect, wherein the encrypted payment information is encrypted using base64 encoding.

According to a thirty-third aspect, the present systems and methods may include, the method of the twenty-sixth aspect or any other aspect, wherein the credit card data includes: A) a personal account number; B) an expiration date; C) a CVV code; D) a first name; and E) a last name.

According to a thirty-fourth aspect, the present systems and methods may include, the method of the twenty-sixth aspect or any other aspect, wherein a processor transmits a client identifier to the third-party.

According to a thirty-fifth aspect, the present systems and methods may include, the method of the twenty-sixth aspect or any other aspect, wherein a processor transmits a reference number to the third-party, the reference number for identifying a decryption request.

According to a thirty-sixth aspect, the present systems and methods, in various embodiments, may include a system for decrypting payloads, the system including: a parser system and a decryption service, the parser system operatively connected to a partner system and the decryption service, wherein the system is configured for: receiving, at the parser system, from the partner system: A) a payload in a particular format and originating from a point of interaction (POI) device; and B) a partner identifier; parsing the payload into: C) a device serial number; and D) at least one encrypted portion; transmitting, by the parser system, the device serial number and the at least one encrypted portion to the decryption service, verifying at the decryption service that the POI device has not been compromised by comparing the particular format of the payload to a fingerprint for the POI device, the fingerprint identified by the device serial number and including a record of a known format for payloads originating from the POI device, upon determining that the POI device has not been compromised: E) decrypting, at the decryption service, the at least one encrypted portion into decrypted credit card information; F) transmitting, from the decryption service to the parser system: 1) an indication of success of decrypting the at least one encrypted portion; and 2) the decrypted credit card information; G) parsing, at the parser system, the decrypted credit card information into: 1) a credit card number data object; 2) an expiration date data object; and 3) a CVV code data object; and H) transmitting to the partner system: 1) the credit card number data object; 2) the expiration date data object; 3) the CVV code data object; and 4) the indication of success.

According to a thirty-seventh aspect, the present systems and methods, in various embodiments, may include a method for decrypting payloads, the method including the steps of: receiving from a partner system: A) a payload in a particular format and originating from a point of interaction (POI) device; and B) a partner identifier; parsing the payload into: C) a device serial number; and D) at least one encrypted portion; verifying that the POI device has not been compromised by comparing the particular format of the payload to a fingerprint for the POI device, the fingerprint identified by the device serial number and including a record of a known format for payloads originating from the POI device, upon determining that the POI device has not been compromised: E) decrypting the at least one encrypted portion data object into decrypted credit card information; F) parsing the decrypted credit card information into: 1) a credit card number discrete data object; 2) an expiration date discrete data object; and 3) a CVV code discrete data object; and G) transmitting to the partner system based in at least in part on the partner identifier: 1) the credit card number discrete data object; 2) the expiration date discrete data object; 3) the CVV code discrete data object; and 4) an indication of success of decryption of the at least one encrypted portion. According to a thirty-eighth aspect, the present systems and methods may include, the method of the thirty-seventh aspect or any other aspect, wherein the device serial number and the at least one encrypted portion are discrete data objects.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an exemplary system environment, according to one embodiment of the present disclosure.

FIG. 2 illustrates an exemplary flowchart of an exemplary parser, according to one embodiment of the present disclosure.

FIG. 3 illustrates a schematic diagram of an exemplary system environment, according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

According to various aspects of the present disclosure, and in one embodiment, the present systems and methods allow a third party entity (e.g., a partner) to transmit payloads received from point of interaction (“POI”) devices to a system for parsing and decrypting, such that the partner may receive the information needed for processing payment specifically formatted such that the data can be further processed. In traditional partner-included payment systems, upon receipt of a payload, partners are typically required to conduct the following steps in order to receive authorization of payment: 1) determine where to send the payload (in some embodiments, determined based on a Key Sequence Indicator (“KSI”) value included in the payload); 2) determine the type of device that sent the payload; 3) call a subroutine to pull out (parse) needed fields from the payload, including: a) serial number; b) key sequence number (“KSN”) value; c) encrypted track 1; d) encrypted track 2; 4) send the parsed data to the decryption system; 5) process a response from the decryption system; and 6) send the decrypted payload to a processor for authorization of payment. In certain embodiments, a particular partner may receive payloads from any number of POI devices and each POI device may format payloads differently (even from the same manufacturer). As such, each new device that the particular partner adds to its network of devices potentially represents a new development effort (e.g., to process and parse the payload to extract a-d, above). According to various aspects of the present disclosure, the present systems and methods eliminate the need for the partner to parse the needed fields prior to receiving decrypted payload information suitable for payment authorization.

In various embodiments, the present systems include one or more POI devices, for example, an IDTECH SecuRED™ magnetic stripe card reader or an Ingenico iPP 320 payment terminal (although any magnetic stripe card reader or terminal that supports encryption of electronic payment data is contemplated as part of this system). According to certain embodiments, the systems include a third-party entity (e.g., a partner) operatively connected to the one or more POI devices and configured to receive encrypted payload information (e.g., electronic payment processing information) from the one or more POI devices.

In particular embodiments, the systems described herein include a parser configured for receiving and transmitting information from or to any suitable entity. The parser may, in various embodiments, be configured to receive a payload from the one or more POI devices, and to parse the payload as necessary for extracting payment processing information needed to obtain payment authorization. In one or more embodiments, the parser may transmit parsed data to a decryption service for decrypting the parsed electronic data into unencrypted, readable data that may be used to obtain payment authorization. In at least one embodiment, the parser receives unencrypted data from a decryption service and transmits that unencrypted data over a secure channel to the partner for payment authorization.

The systems and methods described herein are related to a payload parser system, which is a specific improvement to payment processing solutions. In particular, the systems and methods herein improve payment processing systems by parsing payloads prior to and after decryption. This technical innovation, in some embodiments, reduces coding and programming burdens on entities that receive payloads (but do not decrypt the payloads) and may support a more efficient payment processing environment.

### Exemplary Environment

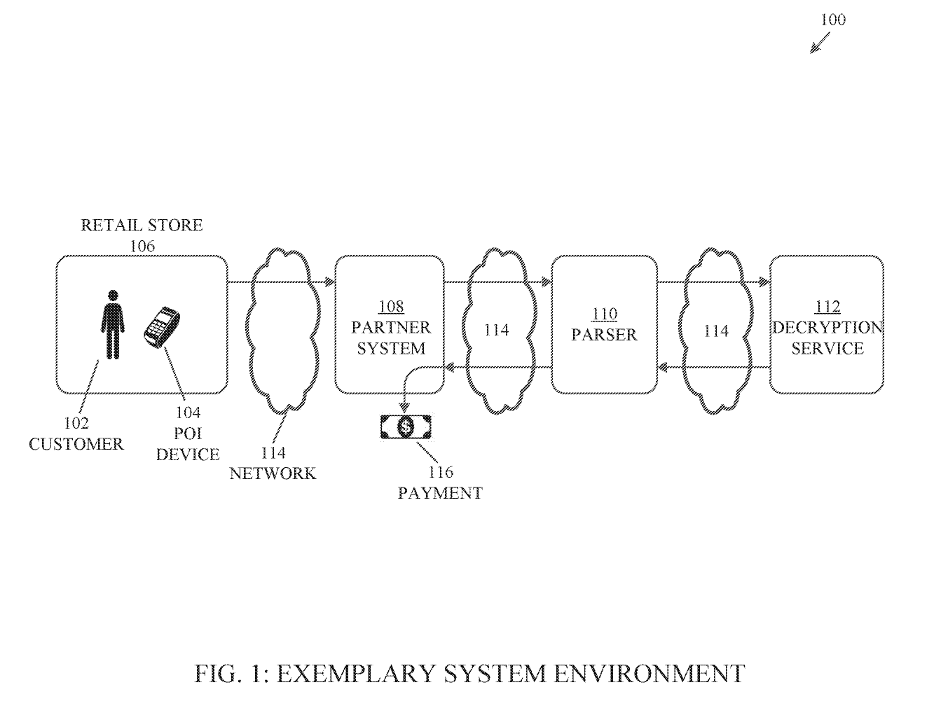

Referring now to the figures, for the purposes of example and explanation of the fundamental processes and components of the disclosed systems and methods, reference is made to FIG. 1, which illustrates an exemplary, high-level overview 100 of one embodiment of the systems and methods herein. As will be understood and appreciated, the exemplary, high-level overview 100 shown in FIG. 1 represents merely one approach or embodiment of the present system, and other aspects are used according to various embodiments of the present system. In particular, FIG. 1 depicts a particular example in which a customer 102 at retail store 106 uses a point of interaction (“POI”) device 104 (e.g., electronic payment terminal) to pay for the goods he or she just purchased. After being sent to a third party entity (e.g., partner 108), the encrypted data from the customer's purchase is sent first to a parser 110 and then to a decryption service 112, before being sent back to the partner 108 via the parser 110. Further, FIG. 1 depicts how various systems in this environment interact in at least one embodiment of the systems and methods described herein.

As shown in FIG. 1, a customer 102 uses a POI device 104 to pay for goods or services received at a retail location 106. In various embodiments, the POI device may be any suitable device capable of accepting and processing customer payments electronically. In particular embodiments, the POI device 104 is operatively connected to a partner 108, such that the POI device 104 may transmit payloads (e.g., electronic payment information) to the partner 108. In one or more embodiments, the partner 108 may be an entity (e.g., a clearinghouse) designated to batch process payloads, or any other suitable entity. In certain embodiments, the partner 108 is operatively connected to a parser 110, such that the partner 108 may transmit and receive payloads to and from the parser 110. In one embodiment, a parser 108 is a system for splitting payloads into multiple components for decryption (of the encrypted components). In various embodiments, the parser 110 may be operatively connected to a decryption service 112. In one or more embodiments, the decryption service 112 may receive a parsed payload from a parser 110 (or a portion of the parsed payload), decrypt the parsed payload into usable data, and then transmit the usable data back to the parser 110. Further, as shown, the various components of this exemplary environment are operatively connected via one or more networks 114.

In one embodiment, the network 114 may be, but is not limited to the Internet, and may involve the usage of one or more services (e.g., a Web-deployed service with client/service architecture, a corporate Local Area Network (LAN) or Wide Area Network (WAN), a cellular data network, or through a cloud-based system). Moreover, as will be understood and appreciated by one having ordinary skill in the art, various networking components like routers, switches, hosts, etc. are typically involved in these communications. Although not shown in FIG. 1, such communications may include, in various embodiments, one or more secure networks, gateways, or firewalls that provide additional security from unwarranted intrusions by unauthorized third parties and cyber-attacks.

Assume, as a discussion example, that a customer 102 is using a credit card to purchase apparel at a retail store 106. The retail store 106 is using a POI device 104 operatively connected to a third-party entity (e.g., partner 108) for batch processing customer electronic payment information (e.g., payloads). As will be understood by a person of ordinary skill in the art, a POI device is an electronic device used to process payments at retail and other business locations. Generally, a POI device can process credit cards, debit cards, and any other suitable forms of electronic payments.

Upon making his or her purchase, the POI device sends the payload to the partner 108 for processing and authorization of payment. To preserve and protect the identity of the customer 102 and his or her banking information, the payload is encrypted prior to transmission to the partner 108, however the partner cannot receive authorization of payment while the payload is in an encrypted format. Thus, and continuing with the example, the partner 108 transmits the encrypted payload to a parser 110 for splitting the encrypted payload into multiple components (e.g., serial number, key sequence number, cipher block chaining (“cbc”) vector, encrypted track 1, encrypted track 2, expiration date, card verification value (“CVV”) code, etc.). Upon splitting, i.e., parsing the payload, the encrypted, parsed payload is transmitted to a decryption service 112, where the payload is decrypted and then transmitted back to the parser 108 in a readable format. Further continuing with the example, the decrypted payload is then parsed into usable components again and transmitted back to the partner 108, such that the partner 108 may process and receive authorization of payment 116 for the apparel purchased by the customer 102 using his or her credit card.

As will be understood from the discussions herein, the above particular example is merely exemplary functionality of the systems and methods described herein. For example, the above describes the authorization of payment process for a customer payment made at a POI device using a credit card, but the systems and methods herein may be useful for any use in connection with point of sale transaction processing using a variety of point of sale devices and/or payment methods.

### Exemplary Parser Process

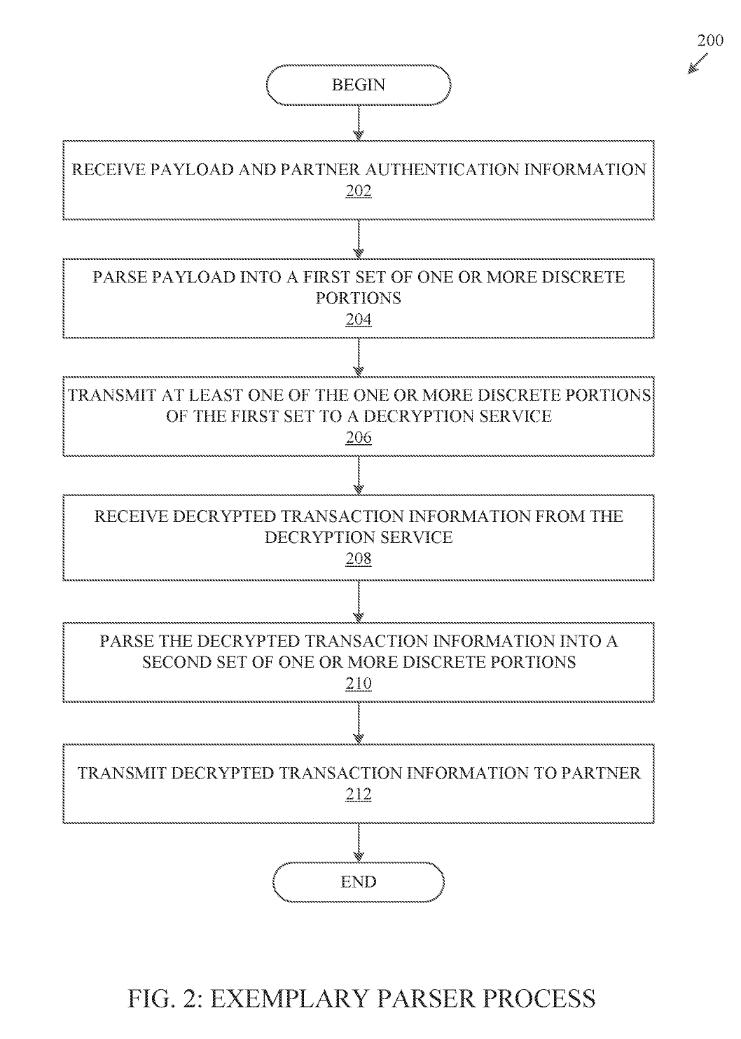

FIG. 2 illustrates an exemplary flowchart of an exemplary parser process 200, according to one embodiment of the present disclosure. As will be understood by a person having ordinary skill in the art, the steps and processes shown in FIG. 2 (and those of all other flowcharts and sequence diagrams shown and described herein) may operate concurrently and continuously, are generally asynchronous and independent, and are not necessarily performed in the order shown.

In one embodiment, and as shown in FIG. 2, the exemplary process begins with step 202, in which the system receives a payload and partner authentication information.

In one embodiment, the system may receive both the payload and partner authentication information from a partner (e.g., the system may receive the payload and the partner authentication information together or separately). In another embodiment, the system may receive the payload and/or the partner authentication information from a POI device. In various embodiments, the partner authentication information may include a partner identifier and/or a partner key or password such that the system may verify the identity of the partner. In particular embodiments, the system may also receive additional information from the partner and/or the POI device. In these embodiments (and others), the system may receive information including, but not limited to: a reference number to identify the specific transaction, a client identifier to identify the proprietor of the POI device, the type of encoding used in the payload (e.g., hexadecimal, Unicode, binary coded decimal, base64 etc.), and any other suitable types of information. In various embodiments, the system may communicate with the partner over a secure channel.

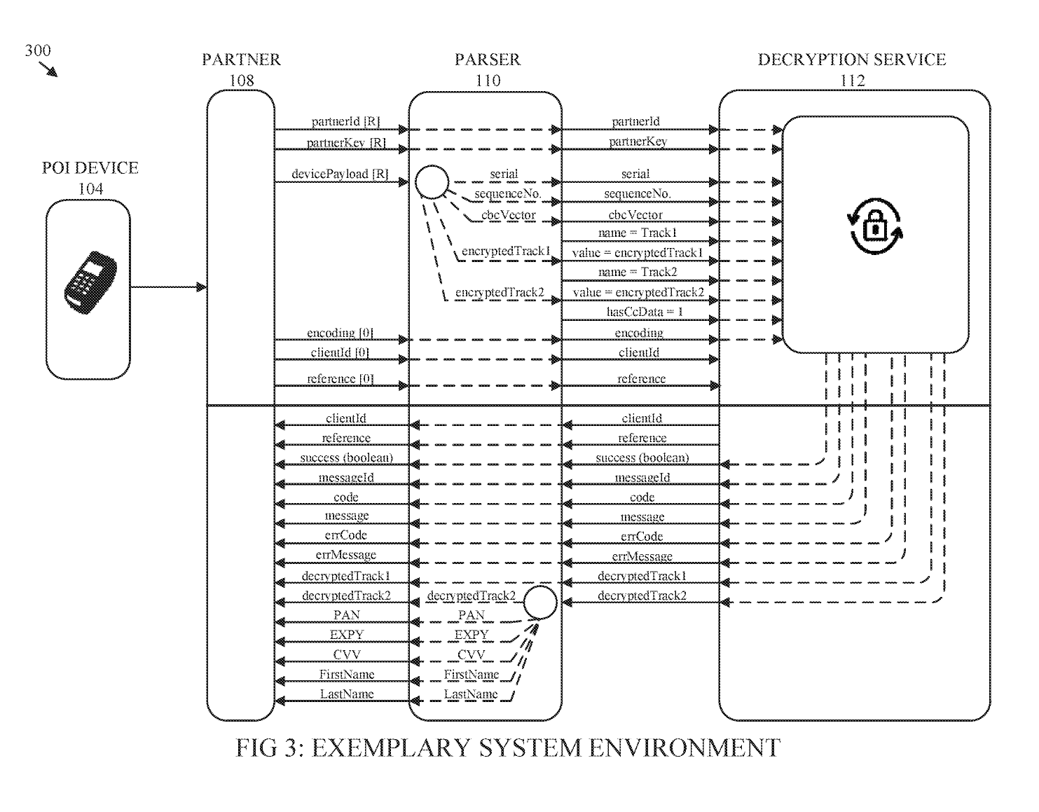

At step 204, the system is configured to parse the payload into a first set of one or more discrete portions. In one or more embodiments, the discrete portions may include, but are not limited to: a device serial number, a key sequence number, a cbc vector, at least one encrypted track containing the payment data (e.g., credit card number, CVV code, expiration date, etc.), and any other like elements. In particular embodiments, the system is configured to parse the payload using an executable program or other construct generated from a software development kit (“SDK”) (e.g., Parser SDK). In various embodiments, and as discussed in FIG. 3 herein, the system may parse the payload by first determining the format of the payload, such that the location of the first set of one or more discrete objects is known prior, or relatively contemporaneous, to initiating the parser process 200.

Turning now to step 206, the system is configured to transmit at least one of the one or more discrete portions of the first set to a decryption service. In various embodiments, the system may transmit the data wirelessly (e.g., via Wi-Fi, Bluetooth, Zigbee, etc.). In particular embodiments, the system may transmit the data over a hard-wired connection (e.g., Ethernet, USB, etc.).

In certain embodiments, the system is configured to format the data for transmission into a JavaScript Object Notation (“JSON”) data object or other data construct (e.g., eXtensible Markup Language (“XML”), YAML Ain't Markup Language (“YAML”), Comma Separated Values (“CSV”), etc.). In one or more embodiments, the system may transmit the parsed payload by itself (e.g., the first set of the one or more discrete portions) or in combination with the other data elements received at step 202 (e.g., partner identifier, partner key, client identifier, type of encoding, reference number, etc.).

In at least one embodiment, the decryption service may employ the methods and/or systems discussed in U.S. patent application Ser. No. 14/663,238, filed on Mar. 19, 2015, and entitled “SYSTEMS AND METHODS FOR DECRYPTION AS A SERVICE,” incorporated herein by reference in its entirety.

At step 208, the system receives the decrypted transaction information from the decryption service. In particular embodiments, the decrypted transaction information may include information including, but not limited to: a client identifier to identify the proprietor of the POI device; a reference number to identify the specific transaction; a success or failure indicator to indicate whether the payload was successfully decrypted;

an error message with error code to indicate the existence and type of an error; a message, message identifier, and message code to indicate and record any messages received from the decryption service; one or more decrypted tracks containing the payment data, and any other like elements. In various embodiments, the system is configured to receive the data in JSON format or any suitable data format (e.g., XML, YAML, CSV, etc.).

At step 210, the system is configured to parse the decrypted transaction information into a second set of one or more discrete portions. In various embodiments, the decrypted transaction information may include the one or more decrypted tracks. In particular embodiments, the system may parse the one or more decrypted tracks into readable payment data (e.g., credit card number, CVV code, expiration date, etc.) for further processing. In particular embodiments, the system is configured to parse the payload using an executable program or other construct generated from an SDK (e.g., Parser SDK).

At step 212, the system is configured to transmit the decrypted transaction information to the partner, such that the partner may use the decrypted transaction information to obtain payment authorization. In various embodiments, the system is configured to transmit both the decrypted transaction information received at step 208, and the parsed decrypted transaction information derived at step 210. In particular embodiments, the system may transmit information including, but not limited to: a client identifier to identify the proprietor of the POI device; a reference number to identify the specific transaction; a success or failure indicator to indicate whether the payload was successfully decrypted; an error message with error code to indicate the existence and type of an error; a message, message identifier, and message code to indicate and record any messages received from the decryption service; one or more decrypted tracks containing the payment data (e.g., credit card number, CVV code, expiration date, etc.), at least one decrypted track such that the payment data is in a parsed and readable format; and any other suitable information. In certain embodiments, the system may also transmit additional information to the partner for added verification and security, such as a device serial number, a key sequence number, and a cbc vector. In one or more embodiments, the system may transmit the decrypted transaction information to the partner using JSON data formatting or any other suitable data format (e.g., XML, YAML, CSV, etc.).

In various embodiments, the partner may receive the decrypted transaction information from the parser, such that the partner may use the decrypted transaction information to obtain payment authorization. In one or more embodiments, the partner may obtain payment authorization from a bank, credit card network (e.g., Visa®, Mastercard®, American Express®, etc.), or other financial institution.

Referring now to FIG. 3, a schematic diagram 300 of an exemplary system environment is shown, according to one embodiment of the present disclosure. FIG. 3 shows the system inputs and outputs discussed above in relation to FIG. 2, and how the different components interact with each other, and with the parser 110 specifically.

In various embodiments, and as discussed above, a partner 108 receiving an encrypted payload from a POI device 104, may transmit the received payload to a parser 110 over a secure channel (e.g., secure sockets layer (“SSL”), transport layer security (“TSL”), virtual private network (“VPN”), etc.), such that the payload may be parsed into a first set of one or more discrete portions prior to decryption. In particular embodiments, in addition to transmitting the payload, the partner 108 may also transmit an encoding value to the parser 110, such that the format of the payload is known to the parser 110. In various embodiments, the parser 110 may also detect the format of the payload without receiving an encoding value. The format of the payload may vary and may be in any suitable format as discussed herein, such as character, hexadecimal, or base64. In certain embodiments, the format of the payload may be formatted as:

FORMAT_CIPHERED_[_KSN][TRACK1][TRACK2][_DSN].

In this format, in particular embodiments, “CIPHERED” is the encryption algorithm and may be, for example, RAW (data is unencrypted), Triple Data Encryption Standard (“TDES”) (may include a derived unique key per transaction (“DUKPT”) for additional security), or Advanced Encryption Standard (“AES”) (may include DUKPT for additional security). In one or more embodiments, TRACK1 and TRACK2 may contain the encoded credit card data, whereby each track of card data may include information including, but not limited to: the primary account number (“PAN”) or credit card number, the CVV code, the expiration date (“EXPY”), the first name, the last name, and any other suitable information. In various embodiments, KSN may be the key sequence number, and DSN may be the device serial number of the payload originating POI device 104. In certain embodiments, the different components or sections of the payload may be separated in string by a delineation character or symbol (e.g., ‘;’ or ‘:’ or ‘?’ or other suitable character).

As an example, and in various embodiments, once a customer 102 completes an electronic payment transaction at a POI device 104, the customer's 102 payment information is compiled in a payload (e.g., “02C400C037001C0A8692;611********331=2212;***?*15=090220=2C856EC5E0250 25;00002352151215111), whereby the customer's 102 electronic payment information is combined with a KSN, a DSN, and other suitable data to facilitate the payment transaction, and transmitted to a partner 108 for authorization of payment. The payload may be transmitted to the partner 108 along with an encoding value (e.g., “encoding [1]” to signal hexadecimal encoding), and/or several other identifying information (e.g., a client identifier, and a reference number).

Continuing with this example, prior to obtaining authorization of payment, the partner 108 transmits the payload to a parser 110, such that the parser 110 may split the payload into multiple sections or components (e.g., KSN=02C400C037001C0A8692, TRACK1=611********331=2212, TRACK2=***?*15=090210=2C856EC5E025025, and DSN=00002352151215111) for decryption by a decryption service 112. In various embodiments, in addition to the payload, the partner 108 may transmit other identifying information (e.g., an encoding value, a partner identifier, a partner key, a client identifier, and a reference number) to the parser 110 for verification and security. In at least one embodiment, the parser 110 then transmits the parsed data (and any other suitable data) to a decryption service 112, such that the decryption service 112 may decrypt the data.

In particular embodiments, the decryption service 112 may verify the data prior to decryption using any suitable verification method, including but not limited to, generating a fingerprint for the POI device 104 based on the format of payloads received from the POI device 104, and then comparing the payload received to the fingerprint as discussed in U.S. patent application Ser. No. 14/591,171, filed on Jan. 7, 2015, and entitled “SYSTEMS AND METHODS FOR FACILITATING DECRYPTION OF PAYLOADS RECEIVED FROM ENCRYPTION DEVICES,” incorporated herein by reference in its entirety. If the data is unable to be verified, in various embodiments, the decryption service 112 may reject the payload. In at least one embodiment, the parser 110 may verify the data/payload (e.g., opposed to, or in addition to, the decryption service 112) in any suitable way, including, but not limited to, the fingerprint technique described above.

In one or more embodiments, if the data is successfully verified, the decryption service 112 will decrypt the parsed data transmitted by the parser 110, and send the decrypted data to the parser 110 (and potentially other information), including but not limited to: a client identifier to identify the proprietor of the POI device; a reference number to identify the specific transaction; a success or failure indicator to indicate whether the payload was successfully decrypted; an error message with error code to indicate the existence and type of an error; a message, message identifier, and message code to indicate and record any messages received from the decryption service; one or more decrypted tracks containing the payment data, and any other like elements.

In particular embodiments, the information returned to the parser 110 is similar to the information received from the parser 110 (e.g., the decryption service 112 may receive ENCRYPTEDTRACK1, and the decryption service may transmit DECRYPTEDTRACK1). In certain embodiments, the information returned to the parser 110 is different than the information received from the parser 110 (e.g., the parser 110 may transmit the serial number to the decryption service 112, but the decryption service 112 may not transmit the serial number back to the parser 110).

In various embodiments, the data is transmitted back to the parser 110 in a decrypted format known to the parser 110 (e.g., 6011013333333331;090220;2212;John;Doe). In the current example, and in various embodiments, the format of decrypted data transmitted to the parser 110 may be formatted as:

[PAN][EXPY][CVV[FIRSTNAME][LASTNAME].

In this format, the different components or sections of the decrypted payload may be separated in string by a delineation character or symbol (e.g., ‘;’ or or ‘?’ or other suitable character).

Continuing with the current example, the parser 110 parses the decrypted data and transmits the decrypted data to the partner 108 in a usable format (e.g., PAN=6011013333333331, EXPY=Sep. 2, 2020, CVV=2212, FIRSTNAME=John, and LASTNAME=Doe). In particular embodiments, in addition to the decrypted data, the parser 110 may transmit additional information to the partner 108, including but not limited to: a client identifier to identify the proprietor of the POI device; a reference number to identify the specific transaction; a success or failure indicator to indicate whether the payload was successfully decrypted; an error message with error code to indicate the existence and type of an error; and a message, message identifier, and message code to indicate and record any messages received from the decryption service.

The partner 108, in particular embodiments, may then utilize the decrypted data to authorize payment on the customer's 102 completed electronic payment transaction.

Exemplary Architecture From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a computer.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a computer to perform one specific function or a group of functions.

Those skilled in the art will understand the features and aspects of a suitable computing environment in which aspects of the disclosure may be implemented. Although not required, some of the embodiments of the claimed inventions may be described in the context of computer-executable instructions, such as program modules or engines, as described earlier, being executed by computers in networked environments.

Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed invention are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the invention is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed inventions will be readily discernible from the description herein, by those of ordinary skill in the art. Many embodiments and adaptations of the disclosure and claimed inventions other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed inventions. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed inventions. In addition, some steps may be carried out simultaneously, contemporaneously, or in synchronization with other steps.

The embodiments were chosen and described in order to explain the principles of the claimed inventions and their practical application so as to enable others skilled in the art to utilize the inventions and various embodiments and with various modifications as are suited to the particular use contemplated. Alternative embodiments will become apparent to those skilled in the art to which the claimed inventions pertain without departing from their spirit and scope. Accordingly, the scope of the claimed inventions is defined by the appended claims rather than the foregoing description and the exemplary embodiments described therein.

What is claimed is:

1. A system for decrypting payloads, the system comprising a computer server comprising at least one processor configured for:
receiving a payload originating from a point of interaction device and partner authentication information from a partner;
authenticating the partner via the partner authentication information;
parsing the payload into a first set of one or more discrete portions including:
a device serial number;
a key sequence number;
a cbc vector; and
at least one encrypted portion;
transmitting the at least one encrypted portion of the first set to a decryption service, the decryption service for decrypting the at least one encrypted portion;
receiving decrypted credit card information derived from the at least one encrypted portion from the decryption service;
parsing the decrypted credit card information into a second set of one or more discrete portions including:
a credit card number;
an expiration date; and
a CVV code; and
transmitting, to the partner, at least the second set.

2. The system of claim 1, wherein the at least one processor is further configured for:
receiving a client identifier and/or a reference number from the partner;
caching the client identifier and/or the reference number; and
transmitting, to the partner, the client identifier and/or the reference number with the credit card number, the expiration date, and the CVV code.

3. The system of claim 1, wherein the first set comprises discrete data objects.

4. The system of claim 1, wherein the second set comprises discrete data objects.

5. The system of claim 1, wherein the partner authentication information comprises a partner identifier and a partner key.

6. The system of claim 1, wherein the first set is encoded.

7. The system of claim 6, wherein the first set is encoded in hexadecimal format.

8. The system of claim 6, wherein the first set is encoded in Unicode.

9. The system of claim 6, wherein the first set is encoded in binary coded decimal.

10. The system of claim 6, wherein the first set is encoded in base64.

11. The system of claim 1, wherein the point of interaction device is wireless.

12. A method for decrypting payloads, the method comprising:
receiving, at a server, a payload originating from a point of interaction device and partner authentication information from a partner;
authenticating the partner via the partner authentication information;
parsing the payload into a first set of one or more discrete portions including:
a device serial number;
a key sequence number;
a cbc vector; and
at least one encrypted portion;
transmitting the at least one encrypted portion of the first set to a decryption service, the decryption service for decrypting the at least one encrypted portion;
receiving decrypted credit card information derived from the at least one encrypted portion from the decryption service;
parsing the decrypted credit card information into a second set of one or more discrete portions including:
a credit card number;
an expiration date; and
a CVV code; and
transmitting, to the partner, the second set.

13. The method of claim 12, the method further comprising:
receiving a client identifier and/or a reference number from the partner;
caching the client identifier and/or the reference number; and
transmitting, to the partner, the client identifier and/or the reference number with the credit card number, the expiration date, and the CVV code.

14. The method of claim 12, wherein the first set comprises discrete data objects.

15. The method of claim 12, wherein the second set comprises discrete data objects.

16. The method of claim 12, wherein the partner authentication information comprises a partner identifier and a partner key.

17. The method of claim 12, wherein the first set is encoded.

18. The method of claim 17, wherein the first set is encoded in hexadecimal format.

19. The method of claim 17, wherein the first set is encoded in Unicode.

20. The method of claim 17, wherein the first set is encoded in binary coded decimal.

21. The method of claim 17, wherein the first set is encoded in base64.

22. The method of claim 12, wherein the point of interaction device is wireless.
